(19) United States
(12) Patent Application Publication
(10) Pub. No.: US 2010/0108708 A1
(43) Pub. Date: May 6, 2010

(54) HIGH VOLUME, HIGH PRESSURE, REFILLABLE, CONTINUOUS BATTER DISPENSER SYSTEM AND METHOD

(76) Inventor: Michael C. Wawzynski, Jacksonville, FL (US)

Correspondence Address: MARK YOUNG, P.A., 12086 FORT CAROLINE ROAD, UNIT 202, JACKSONVILLE, FL, 32225, US

(21) Appl. No.: 12/261,046

(22) Filed: Oct. 30, 2008

(51) Int. Cl. B67D 5/54; A21C 3/04; B65D 83/00

(52) U.S. Cl. 222/1; 222/529; 222/394

(57) ABSTRACT

A refillable compressed air driven system includes a vessel adapted to hold a determined amount of batter and compressed air, a compressed air inlet port in the vessel, a compressed air outlet port in the vessel, a batter inlet port in the vessel, a batter outlet port in the vessel, a compressed air supply line fluidly connected to the compressed air inlet port and configured to supply compressed air from a compressor through the compressed air supply line to the vessel, an exhaust valve operably coupled to the compressed air outlet port, a hopper operably coupled to the batter inlet port, and a batter inlet valve disposed between the hopper and the vessel, and a dispenser operably coupled to the batter outlet port. A method of use entails loading batter through the hopper into the vessel, charging the vessel with compressed air to a determined pressure range, dispensing batter through the dispenser to form units of food products until substantially all of the batter loaded in the vessel is dispensed, evacuating the compressed air, and repeating the foregoing steps.

### FIELD OF THE INVENTION

This invention generally relates to batter dispensing, and more particularly, to a high-pressure, compressed air system and method for dispensing batter and quickly refilling the system without disassembly.

### BACKGROUND

Many cultures have dishes made by deep frying dough of one form or another. By way of example and not limitation, funnel cake, a sweet pastry originally associated with the Pennsylvania Dutch region of the United States, is quite popular around the United States at ballparks, fairs, festivals and other special events. Funnel cakes are typically made by pouring batter through a funnel into hot oil in a circular pattern and deep frying it until both sides golden-brown. As the batter comes out of the funnel, the web of batter is criss-crossed within a circular diameter to form a lattice which sticks together. Funnel cakes are often served with powdered sugar or other toppings.

Other similar pastries include Zeppoles, which are a light, doughnut hole sized pastry made of deep-fried batter; Beignets popularly associated with the French Qaurter region of New Orleans, La.; and Loukoumas, which is a popular Greek, Turkish, and Middle Eastern/Arabic fried-dough pastry typically coated with sugar syrup or honey and cinnamon, and sometimes sprinkled with sesame.

While such pastries are relatively easy to produce in small volumes, high volume mass production presents unique problems which the prior art has not heretofore solved. For example, manually pouring batter from a ladle or pitcher through a funnel into a deep fryer is inefficient, imprecise, exhausting, unsanitary and messy when performed repeatedly for any extended period of time. The ladle or pitcher must constantly be refilled and inevitably becomes coated with dripped batter. A reservoir of batter from which the ladle or pitcher are refilled remains uncovered and exposed to the ambient environment for extended periods during repeated refilling steps, which is conducive to contamination. Manual pouring is slow and highly imprecise, resulting in highly non-uniform pastries. Holding and pouring the pitcher or ladle for any extended period of time, which may be necessary at any special event, can be exhausting. Conducting a such tedious and exhausting task over a deep fryer is conducive to injury.

While others have developed devices that address some, but not all, of the foregoing issues, the known prior art devices have shortcomings. For example, U.S. Pat. No. 6,216,921 discloses a funnel cake batter dispensing system comprising a beverage container coupled to a liquefied carbon dioxide tank, which is normally used in the dispensing of pre or post mix soft drinks. Unfortunately, the system operates at low-pressure (i.e., less than 35 to 40 psi), which translates into limited volumetric dispensing rate. It also requires a supply tank of liquefied carbon dioxide, which is extremely difficult to transport and must be purchased and stored in advance. Additionally, it is difficult to refill, as refilling entails a complete shut down and removal of the top of the tank.

What is needed is a system and method for quickly and precisely dispensing determined volumes of batter. The system and method should be configured with a large reservoir of batter that enables quickly refilling the system without disassembly. The invention is directed to overcoming one or more of the problems and solving one or more of the needs as set forth above.

### SUMMARY OF THE INVENTION

To solve one or more of the problems set forth above, in an exemplary implementation of the invention, a refillable compressed air driven system is provided for dispensing batter. The system includes a vessel adapted to hold a determined amount of batter and compressed air, a compressed air inlet port in the vessel, a compressed air outlet port in the vessel, a batter inlet port in the vessel, a batter outlet port in the vessel, a compressed air supply line fluidly connected to the compressed air inlet port and configured to supply compressed air through the compressed air supply line to the vessel, an exhaust valve operably coupled to the compressed air outlet port, a hopper operably coupled to the batter inlet port, and a batter inlet valve disposed between the hopper and the vessel, and a dispenser operably coupled to the batter outlet port. Compressed air may be supplied by an air compressor, preferably an oilless air compressor, operably coupled to the compressed air supply line. The vessel includes a lid releasably attached to a base using a plurality of releasable clamps. A pressure relief valve is provided in fluid communication with the vessel and configured to vent compressed air in the vessel in excess of a determined pressure.

A rigid batter line extends from the batter inlet port in the vessel and is adapted to direct batter from the hopper into the vessel. The hopper is operably coupled to the rigid batter line, and the batter inlet valve is fluidly coupled to the rigid batter line and disposed between the hopper and the vessel. The hopper may include a funnel shaped entry configured to feed batter into the rigid batter line.

A flexible dispenser line having a vessel end and a dispenser end is also provided. The vessel end is fluidly connected to the batter outlet and the dispenser end is fluidly connected to the dispenser. The flexible dispenser line is configured to communicate batter from the vessel to the dispenser operably coupled to the batter outlet port. A batter line valve is fluidly coupled to the flexible dispenser line and disposed between the vessel and the dispenser. The dispenser may be manually actuated. Optionally, a controller may be operably coupled to the dispenser and configured to either control a time period during which the dispenser remains in an open state when actuated or maintain the dispenser in an open state when actuated until a determined amount of batter passes through the dispenser.

A method for dispensing batter and enabling quick refilling of a refillable compressed air driven system is also provided. The method entails loading batter through the hopper into the vessel, charging the vessel with compressed air to a determined pressure range, dispensing batter through the dispenser to form units of food products until substantially all of the batter loaded in the vessel is dispensed, evacuating the compressed air, and repeating the foregoing steps. The step of loading batter through the hopper into the vessel may include opening the batter inlet valve, pouring the batter into the hopper, allowing the poured batter to flow from the hopper into the vessel, and closing the batter inlet valve after the batter has flowed into the vessel. The step of charging the vessel with compressed air may include supply compressed air from a compressor into the vessel until a pressure within the determined pressure range is attained. The step of dispensing batter through the dispenser to form units of food products until substantially all of the batter loaded in the vessel is dispensed, may include repetitively actuating the dispenser until an amount of batter for one unit of food product has been dispensed. The step of evacuating the compressed air may include opening the exhaust valve.

### BRIEF DESCRIPTION OF THE DRAWINGS

The foregoing and other aspects, objects, features and advantages of the invention will become better understood with reference to the following description, appended claims, and accompanying drawings, where:

FIG. 1 shows a schematic of an exemplary high-pressure, compressed air system for dispensing batter and enabling quick refilling without disassembly according to principles of the invention; and

FIG. 2 shows a schematic of an exemplary high-pressure, compressed air system for dispensing batter, enabling quick refilling without disassembly, and including controller and operably coupled discharge nozzle configured to control the volume of batter discharged per cycle, according to principles of the invention; and

FIG. 3 shows a perspective view of an exemplary high-pressure vessel assembly according to principles of the invention; and

FIG. 4 shows a flowchart of an exemplary method for dispensing batter and enabling quick refilling without disassembly according to principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the steps, types, shapes, relative sizes, ornamental aspects or proportions of components shown in the figures.

### DETAILED DESCRIPTION

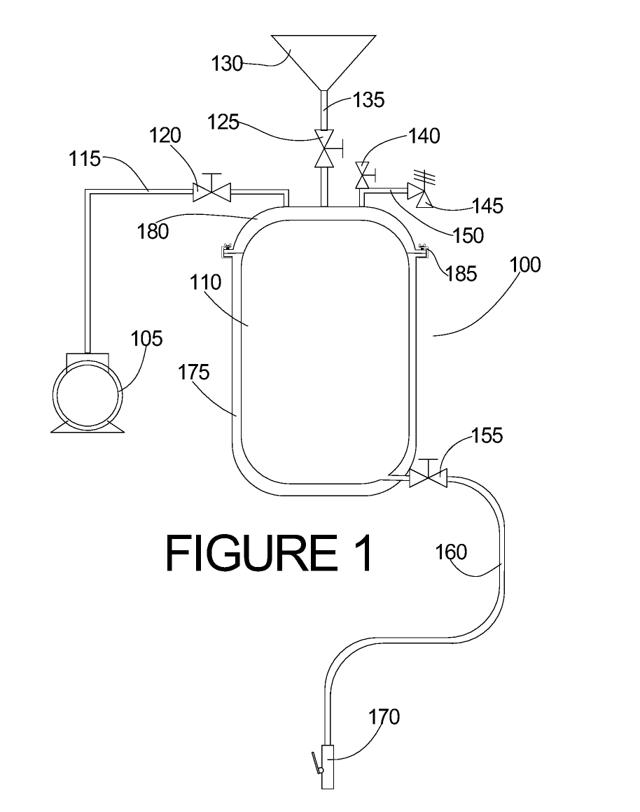

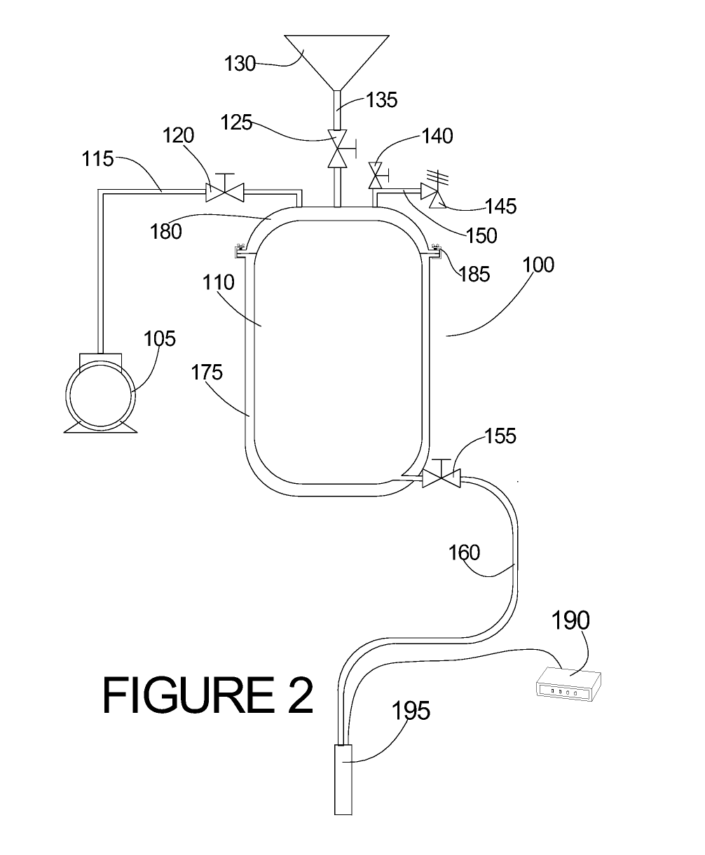

Referring to the Figures, in which like parts are indicated with the same reference numerals, various schematics of an exemplary high-pressure, compressed air system for dispensing batter and enabling quick refilling without disassembly according to principles of the invention are shown in FIGS. 1 and 2. A difference between the embodiments is a manually controlled dispenser 170 in FIG. 1 versus a controller metered dispenser 170 in FIG. 2, as discussed more fully below.

Referring first to FIG. 1, a schematic of an exemplary high-pressure, compressed air system 100 for dispensing batter and enabling quick refilling without disassembly according to principles of the invention is conceptually shown. The system 100 includes a pressure vessel 110, which is a rigid container with an interior compartment designed to hold batter and compressed gas (e.g., compressed air) at a pressure (e.g., about 100 psi) above ambient pressure. The vessel 110 is intended for use as a pressure container from which contained batter is urged through a dispenser 170 under the influence of compressed air. In a preferred embodiment the vessel includes a removable lid 180 and a base 175 releasably attached using clamps 185. Removal of the clamps 185 allows removal of the lid 180 from the base 175 to facilitate access to the interior compartment for cleaning and maintenance.

The vessel 110 is preferably constructed from a nonreactive, food-safe material with strength and durability suitable for the pressures experienced. In an exemplary embodiment the material is stainless steel. The pressures of operation are greater than 50 psi, preferably 80 to 110 psi, and more preferably 100 psi.

The vessel 110 is equipped with various couplings, inlets, outlets and valves. A compressed gas (e.g., air) line 115 extends from an output port of a compressor 105 to an inlet port of the vessel 110. The line is any conduit suitable for directing a flow of compressed air from the compressor 105 to the vessel 110, such as (for example) braided, flexible, abrasion resistant polyurethane air hose, a rigid pipe, some other compressed air conduit material or a combination thereof. One or more filters and/or separators may optionally be operably coupled to the line to remove oil, moisture, dirt, pipe scale, liquid aerosol and other contaminants from the compressed air.

A compressed gas valve 120 is operably coupled to the compressed gas line 115, disposed between the output port of a compressor 105 and the inlet port of the vessel 110. Operating positions for the valve 120 may be either shut (closed) so that no flow at all goes through, fully open for maximum flow, or partially open to any degree in between. The valve 120 may be controlled manually with a handle attached to a valve stem. Alternatively, the valve 120 can be controlled by an actuator such as an electric motor or solenoid, pneumatic actuator controlled by air pressure, or a hydraulic actuator controlled by the pressure of a liquid such as oil or water.

A batter line 135 extends from an output port of a hopper 105 to an inlet port of the vessel 110. The line is a rigid conduit suitable for supporting the hopper 130 when it is full of batter 130 and suitable for directing a flow of batter from the hopper 130 through a batter inlet port and into the vessel 110. Such a line 135 may, for example, be comprised of stainless steel pipe.

A batter line valve 125 is operably coupled to the batter line 135, disposed between the output port of the hopper 130 and a batter inlet port of the vessel 110. Operating positions for the valve 125 may be either shut (closed) so that no flow at all goes through, fully open for maximum flow, or partially open to any degree in between. The valve 125 may be controlled manually with a handle attached to a valve stem. Alternatively, the valve 125 can be controlled by an actuator such as an electric motor or solenoid, pneumatic actuator controlled by air pressure, or a hydraulic actuator controlled by the pressure of a liquid such as oil or water.

A batter line 135 extends from an output port of a hopper 105 to an inlet port of the vessel 110. The line is a strong, rigid conduit suitable for supporting the hopper 130 when it is full of batter 130 while directing a flow of batter from the hopper 130 through a batter inlet port and into the vessel 110. Such a line 135 may, for example, be comprised of stainless steel pipe.

A batter line valve 125 is operably coupled to the batter line 135, disposed between the output port of the hopper 130 and a batter inlet port of the vessel 110. Operating positions for the valve 125 may be either shut (closed) so that no flow at all goes through, fully open for maximum flow, or partially open to any degree in between. The valve 125 may be controlled manually with a handle attached to a valve stem. Alternatively, the valve 125 can be controlled by an actuator such as an electric motor or solenoid, pneumatic actuator controlled by air pressure, or a hydraulic actuator controlled by the pressure of a liquid such as oil or water.

The hopper 130 is a bin-like or funnel-like entry configured to feed batter into the batter line 135 to supply batter to the vessel 110. The hopper 130 is open above, and tapers, being thinner at the bottom where it feeds into the batter line 135 leading to the container.

An exhaust line 150 extends from an exhaust port of the vessel to an exhaust valve 140 and a pressure relief valve 145. The line is a conduit suitable for supporting the exhaust valve 140 and pressure relief valve 145. Such a line 150 may, for example, be comprised of stainless steel pipe.

A exhaust valve 145 operably coupled to the exhaust line 150, disposed between the exhaust port of the vessel 110 and the pressure relief valve 145, may be either shut (closed) so that no flow at all goes through, fully open for maximum flow, or partially open to any degree in between. The valve 145 may be controlled manually with a handle attached to a valve stem. Alternatively, the valve 145 can be controlled by an actuator such as an electric motor or solenoid, pneumatic actuator controlled by air pressure, or a hydraulic actuator controlled by the pressure of a liquid such as oil or water.

The pressure relief valve 145 protects the tank from excessive pressure. The relief valve 145 is designed or set to open at a predetermined pressure (e.g., in excess of 100 psi) to protect the vessel 110 and other equipment from being subjected to pressures that exceed their design limits. When the pressure setting is exceeded, the relief valve 145 becomes a “path of least resistance” as the valve 145 is forced open and excess gas is vented to the atmosphere. As pressurized gas is exhausted, the pressure inside the vessel 110 will drop. Once it reaches the valve's re-seating pressure (e.g., 100 psi), also known as the blowdown, the valve will re-close.

A batter dispensing line 160 extends from an output port of the vessel 110 to a dispenser 170. The line is any conduit suitable for directing a flow of batter from the vessel 110 to the dispenser 170, such as (for example) braided, flexible, abrasion resistant polyurethane air hose.

A batter dispensing valve 155 is operably coupled to the batter dispensing line 160, disposed between the output port of the vessel 110 and the dispenser 170. Operating positions for the valve 155 may be either shut (closed) so that no flow at all goes through, fully open for maximum flow, or partially open to any degree in between. The valve 155 may be controlled manually with a handle attached to a valve stem. Alternatively, the valve 155 can be controlled by an actuator such as an electric motor or solenoid, pneumatic actuator controlled by air pressure, or a hydraulic actuator controlled by the pressure of a liquid such as oil or water.

A batter dispenser 170 is operably coupled to the end of the batter dispensing line 160 opposite the vessel 110. The batter dispenser 170 conceptually shown in FIG. 2 is a manually actuated or automated valve. When the dispenser 170 is open, batter, pushed by the gas in the pressurized vessel 110, flows from the dispenser. The dispenser 170 may be either shut (closed) so that no flow at all goes through, fully open for maximum flow, or partially open to any degree in between. The dispenser 170 may be controlled manually with a lever. Alternatively, the dispenser 170 can be controlled by an actuator such as an electric motor or solenoid, pneumatic actuator controlled by air pressure, or a hydraulic actuator controlled by the pressure of a liquid such as oil or water.

To use the system to make funnel cakes, dispensed batter may be deposited into hot oil in a circular pattern and deep fried until both sides of the deposited batter are cooked golden-brown. As the batter exits the dispenser 170, the web of batter is criss-crossed within a circular diameter to form a lattice which sticks together. Funnel cakes are often served with powdered sugar or other toppings.

Referring now to FIG. 2, a schematic of another exemplary high-pressure, compressed air system 100 for dispensing batter and enabling quick refilling without disassembly according to principles of the invention is conceptually shown. The system 100 includes a pressure vessel 110, which is a rigid container with an interior compartment designed to hold batter and compressed gas (e.g., compressed air) at a pressure (e.g., about 100 psi) above ambient pressure. The vessel 110 is intended for use as a pressure container from which contained batter is urged through a dispenser 195 under the influence of compressed air. In a preferred embodiment the vessel includes a removable lid 180 and a base 175 releasably attached using clamps 185. Removal of the clamps 185 allows removal of the lid 180 from the base 175 to facilitate access to the interior compartment for cleaning and maintenance.

The vessel 110 is preferably constructed from a nonreactive, food-safe material with strength and durability suitable for the pressures experienced. In an exemplary embodiment the material is stainless steel. The pressures of operation are greater than 50 psi, preferably 80 to 110 psi, and more preferably 100 psi.

The vessel 110 is equipped with various couplings, inlets, outlets and valves. A compressed gas (e.g., air) line 115 extends from an output port of a compressor 105 to an inlet port of the vessel 110. The line is any conduit suitable for directing a flow of compressed air from the compressor 105 to the vessel 110, such as (for example) braided, flexible, abrasion resistant polyurethane air hose, a rigid pipe, some other compressed air conduit material or a combination thereof. One or more filters and/or separators may optionally be operably coupled to the line to remove oil, moisture, dirt, pipe scale, liquid aerosol and other contaminants from the compressed air.

A compressed gas valve 120 is operably coupled to the compressed gas line 115, disposed between the output port of a compressor 105 and the inlet port of the vessel 110. Operating positions for the valve 120 may be either shut (closed) so that no flow at all goes through, fully open for maximum flow, or partially open to any degree in between. The valve 120 may be controlled manually with a handle attached to a valve stem. Alternatively, the valve 120 can be controlled by an actuator such as an electric motor or solenoid, pneumatic actuator controlled by air pressure, or a hydraulic actuator controlled by the pressure of a liquid such as oil or water.

A batter line 135 extends from an output port of a hopper 105 to an inlet port of the vessel 110. The line is a rigid conduit suitable for supporting the hopper 130 when it is full of batter 130 and suitable for directing a flow of batter from the hopper 130 through a batter inlet port and into the vessel 110. Such a line 135 may, for example, be comprised of stainless steel pipe.

A batter line valve 125 is operably coupled to the batter line 135, disposed between the output port of the hopper 130 and a batter inlet port of the vessel 110. Operating positions for the valve 125 may be either shut (closed) so that no flow at all goes through, fully open for maximum flow, or partially open to any degree in between. The valve 125 may be controlled manually with a handle attached to a valve stem. Alternatively, the valve 125 can be controlled by an actuator such as an electric motor or solenoid, pneumatic actuator controlled by air pressure, or a hydraulic actuator controlled by the pressure of a liquid such as oil or water.

A batter line 135 extends from an output port of a hopper 105 to an inlet port of the vessel 110. The line is a strong, rigid conduit suitable for supporting the hopper 130 when it is full of batter 130 while directing a flow of batter from the hopper 130 through a batter inlet port and into the vessel 110. Such a line 135 may, for example, be comprised of stainless steel pipe.

A batter line valve 125 is operably coupled to the batter line 135, disposed between the output port of the hopper 130 and a batter inlet port of the vessel 110. Operating positions for the valve 125 may be either shut (closed) so that no flow at all goes through, fully open for maximum flow, or partially open to any degree in between. The valve 125 may be controlled manually with a handle attached to a valve stem. Alternatively, the valve 125 can be controlled by an actuator such as an electric motor or solenoid, pneumatic actuator controlled by air pressure, or a hydraulic actuator controlled by the pressure of a liquid such as oil or water.

The hopper 130 is a bin-like or funnel-like entry configured to feed batter into the batter line 135 to supply batter to the vessel 110. The hopper 130 is open above, and tapers, being thinner at the bottom where it feeds into the batter line 135 leading to the container.

An exhaust line 150 extends from an exhaust port of the vessel to an exhaust valve 140 and a pressure relief valve 145. The line is a conduit suitable for supporting the exhaust valve 140 and pressure relief valve 145. Such a line 150 may, for example, be comprised of stainless steel pipe.

A exhaust valve 145 operably coupled to the exhaust line 150, disposed between the exhaust port of the vessel 110 and the pressure relief valve 145, may be either shut (closed) so that no flow at all goes through, fully open for maximum flow, or partially open to any degree in between. The valve 145 may be controlled manually with a handle attached to a valve stem. Alternatively, the valve 145 can be controlled by an actuator such as an electric motor or solenoid, pneumatic actuator controlled by air pressure, or a hydraulic actuator controlled by the pressure of a liquid such as oil or water.

The pressure relief valve 145 protects the tank from excessive pressure. The relief valve 145 is designed or set to open at a predetermined pressure (e.g., in excess of 100 psi) to protect the vessel 110 and other equipment from being subjected to pressures that exceed their design limits. When the pressure setting is exceeded, the relief valve 145 becomes a “path of least resistance” as the valve 145 is forced open and excess gas is vented to the atmosphere. As pressurized gas is exhausted, the pressure inside the vessel 110 will drop. Once it reaches the valve's re-seating pressure (e.g., 100 psi), also known as the blowdown, the valve will re-close.

A batter dispensing line 160 extends from an output port of the vessel 110 to a dispenser 195. The line is any conduit suitable for directing a flow of batter from the vessel 110 to the dispenser 195, such as (for example) braided, flexible, abrasion resistant polyurethane air hose.

A batter dispensing valve 155 is operably coupled to the batter dispensing line 160, disposed between the output port of the vessel 110 and the dispenser 195. Operating positions for the valve 155 may be either shut (closed) so that no flow at all goes through, fully open for maximum flow, or partially open to any degree in between. The valve 155 may be controlled manually with a handle attached to a valve stem. Alternatively, the valve 155 can be controlled by an actuator such as an electric motor or solenoid, pneumatic actuator controlled by air pressure, or a hydraulic actuator controlled by the pressure of a liquid such as oil or water.

A batter dispenser 195 is operably coupled to the end of the batter dispensing line 160 opposite the vessel 110. The batter dispenser 195 conceptually shown in FIG. 1 is a manually actuated valve that opens by depressing a small lever. When the dispenser 195 is open, batter, pushed by the gas in the pressurized vessel 110, flows from the dispenser. In this embodiment, the dispenser 195 is operably coupled to a controller, which is adapted to control dispensing of a determined amount of batter per dispensing cycle, i.e., per cake, by controlling the time of dispensing at a set pressure or by directly or indirectly measuring or otherwise determining flow rate, mass, or volume of dispensed batter.

In an exemplary implementation, the dispenser 195 comprises a microcontroller controlled dispensing valve, such as a 725HF dispense valve by EFD, Inc., East Providence, R.I., USA., and a corresponding pre-configured or configurable microcontroller, referred to herein as a controller 190, such as a ValveMate™ 7000 controller by EFD, Inc., East Providence, R.I., USA. For the 725HF dispense valve and ValveMate™ 7000 controller valve open time is the primary control of dispensed batter volume. For each cycle, the controller 195 maintains the dispenser in an open state, allowing batter to be dispensed, for a determined amount of time. As the pressure is maintained substantially constant (e.g., at 100 psi) and the batter properties remain substantially the same, substantially the same amounts of batter are dispensed for each such cycle. This embodiment ensures uniformity in weight, i.e., that substantially consistent amounts of batter are dispensed during each cycle (e.g., for each cake). This embodiment also helps ensure uniformity in cooking time, as like size cakes take similar time to cook.

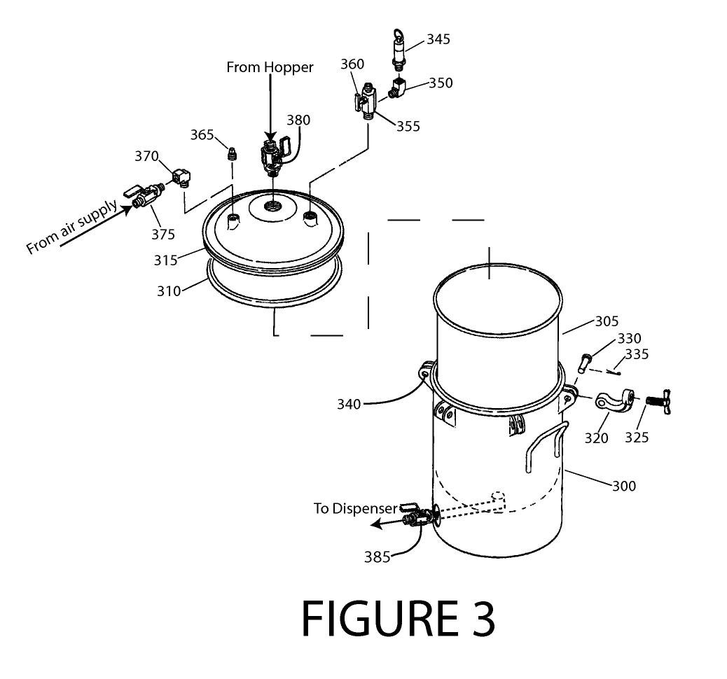

Referring now to FIG. 3, a perspective view of an exemplary high-pressure vessel assembly is conceptually shown to illustrate a specific vessel embodiment, but not to limit the invention thereto. The pressure vessel 300 is a rigid container with an interior compartment designed to hold batter and compressed gas (e.g., compressed air) at a pressure (e.g., about 100 psi) above ambient pressure. The vessel 300 is intended for use as a pressure container from which contained batter is urged through a dispenser 195 under the influence of compressed air. In a preferred embodiment the vessel includes a removable lid 315 and a base 305 releasably attached using clamps 320. Each clamp is pivotally connected to the base 305 using a hinge pivot pin 330, a retaining cotter pin 335 adapted for engagement by the hinge pivot pin 330, and a hinge joint 340 attached to the base 305. A threaded actuator 325 engages a flanged rim 310 of the lid 315 to secure the lid 315 to the base 305. Loosening the threaded actuator allows removal of the lid 315 from the base 305 to facilitate access to the interior compartment for cleaning and maintenance.

The vessel 110 is preferably constructed from a nonreactive, food-safe material with strength and durability suitable for the pressures experienced. In an exemplary embodiment the material is 304 stainless steel, approximately 0.075 to 0.2 inches thick, and can continuously sustain working pressures of approximately 110 psi. The vessel may have any volume capacity, including, but not limited to 5, 10 or 15 gallon.

The vessel 110 is equipped with various couplings, inlets, outlets and valves. A ball valve 375 of 316 Stainless Steel, connects to a 90° elbow 370 (of ⅜×18 NPT Stainless Steel), which connects to a plug 365 (⅜−18 NPT Stainless Steel) that threads into a threaded compressed air input port of the vessel 300. A compressed gas (e.g., air) line will extends from an output port of a compressor to the ball valve 375. The line is any conduit suitable for directing a flow of compressed air from the compressor to the vessel 300, such as (for example) braided, flexible, abrasion resistant polyurethane air hose, a rigid pipe, some other compressed air conduit material or a combination thereof. One or more filters and/or separators may optionally be operably coupled thereto remove oil, moisture, dirt, pipe scale, liquid aerosol and other contaminants from the compressed air.

A ball valve 380 of 316 Stainless Steel is connected to a batter inlet port of the vessel 300. A batter line extends from the ball valve 380 to an output port of a hopper. The line is a rigid conduit suitable for supporting the hopper when it is full of batter and suitable for directing a flow of batter from the hopper through a batter inlet port and into the vessel.

A ball valve 385 of 316 Stainless Steel is connected to a batter outlet port of the vessel 300. A batter dispensing line extends from the ball valve 385 to a dispenser. The line may be any conduit suitable for directing a flow of batter from the vessel 300 to the dispenser, such as (for example) braided, flexible, abrasion resistant polyurethane air hose.

An exhaust manifold 355 with an exhaust valve 360, connects to a 90° elbow 350, which connects to a pressure relief valve 340. The manifold is threaded into compressed air output port of the vessel 300. The exhaust valve 360 may be controlled manually with a handle attached to a valve stem. The pressure relief valve 340 protects the vessel 300 from excessive pressure.

To use the system to make funnel cakes, dispensed batter may be deposited into hot oil in a circular pattern and deep fried until both sides of the deposited batter are cooked golden-brown. As the batter exits the dispenser 195, the web of batter is criss-crossed within a circular diameter to form a lattice which sticks together. Funnel cakes are often served with powdered sugar or other toppings.

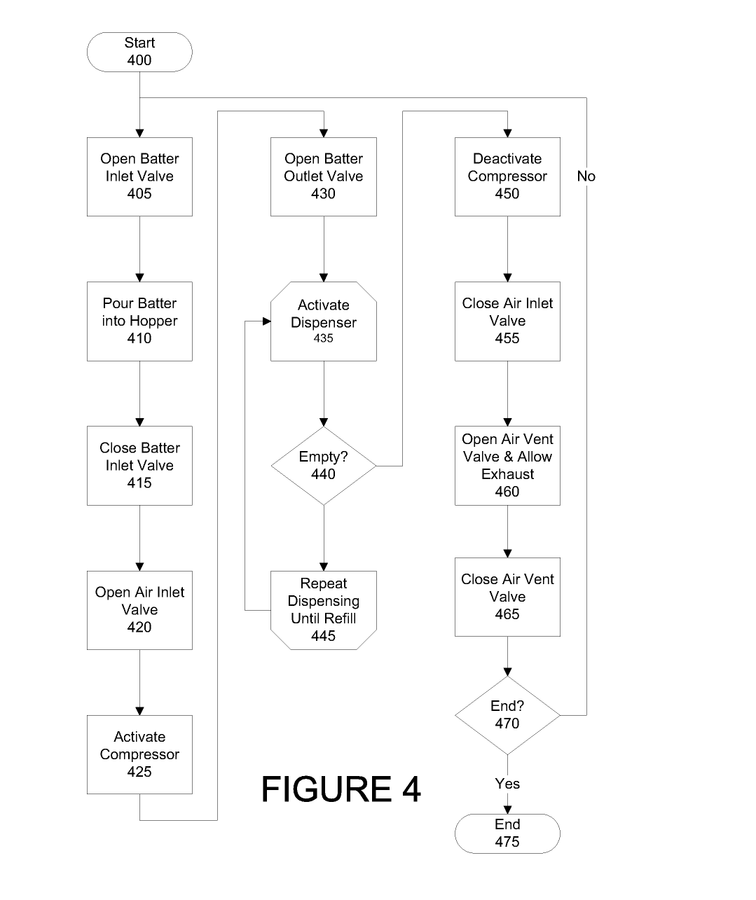

Now, with reference to FIG. 4, a flowchart of an exemplary method for dispensing batter and enabling quick refilling, without disassembly, according to principles of the invention is shown. The process starts 400 after the batter has been prepared. A determined volume (e.g., 5, 10 or 15 gallons) of batter is then loaded into the vessel 110. Loading entails opening the batter inlet valve 125, as in step 405, and pouring the batter into the hopper 130, as in step 410. The poured batter will flow from the hopper 130 into the vessel 110. After the batter has been received by the vessel 110, the batter inlet valve is closed, as in step 415. Now the batter has been loaded into the vessel 110.

Next, the batter-loaded vessel 110 is charged with compressed air. The air inlet valve is opened, as ins step 420 and the compressor is activated, as in step 425. The compressed air fills the ullage of the vessel and urges the batter downwardly. As batter is expelled, more compressed air fills the ullage to maintain a desired pressure.

Next, after the batter-loaded vessel 110 has been charged with compressed air to a determined operating pressure (e.g., 100 psi), the dispensing operation may commence. The batter outlet valve 155 is opened, as in step 430. Then the dispenser is activated to discharge batter for cooking, as in step 435. If the dispenser 170 is manually controlled, then a user actuates the dispenser 170 until an amount of batter for one unit of product (e.g., one funnel cake) has been discharged. If the dispenser 195 is computer controlled (e.g., controlled by controller 190), then a user actuates the dispenser 195 and the controller maintains the dispenser in an open discharge state for a determined period of time and/or until an amount of batter for one unit of product (e.g., one funnel cake) has been discharged. Discharged batter may be deposited into hot oil in a desired (e.g., circular pattern) and deep fried until properly cooked. In the case of funnel cakes, as the batter exits the dispenser 195, the discharged web of batter is crisscrossed within a circular diameter to form a lattice which sticks together. Funnel cakes are often served with powdered sugar or other toppings.

The discharge of batter for one unit of product (e.g., one funnel cake) is a cycle. The dispensing step (step 435) may be repeated, as in step 445, until a determined number of units of product have been made, or until the vessel is empty, as in step 440. The number of cycles for a load of batter is determined by the volume of batter in the vessel and the amount of batter used for each unit of product.

When all or nearly all batter has been dispensed from the vessel 300, the vessel may be refilled. Refilling entails turning off the compressor, as in step 450. The air inlet valve 120 may be closed, as in step 455, to prevent poured batter from entering the compressed air line 115. Then, compressed air is exhausted from the vessel by opening the exhaust valve 140.

A determined volume (e.g., 5, 10 or 15 gallons) of batter is then loaded into the vessel 110. As discussed above, loading entails opening the batter inlet valve 125, as in step 405, and pouring the batter into the hopper 130, as in step 410. The poured batter will flow from the hopper 130 into the vessel 110. After the batter has been received by the vessel 110, the batter inlet valve is closed, as in step 415. Now the new batch of batter has been loaded into the vessel 110.

Next, the batter-loaded vessel 110 is charged with compressed air. The air inlet valve is opened, as in step 420 and the compressor is activated, as in step 425. The compressed air fills the ullage of the vessel and urges the batter downwardly. As batter is expelled, more compressed air fills the ullage to maintain a desired pressure. The process continues for the new batch of batter, as it did for the original batch of batter. The process may end at any time, such as when enough units have been produced, as in step 475.

Advantageously, no disassembly of the vessel is required to refill the system. This minimizes downtime and greatly improves overall productivity. Additionally, because of the high operating pressure, which much greater than 40 psi, the system completes cycles much more quickly than prior art low-pressure batter discharge systems. Thus, more units of product can be produced using a system and methodology according to principles of the invention, than with prior art systems and methodologies.

Another advantage of a system and methodology according to principles of the invention is portability and independence from compressed gas tanks. While any source of food-compatible compressed gas may be utilized, a conventional oilless air compressor is preferred because of the attainable pressures and continuous unlimited supply. In contrast, compressed gas tanks are difficult to transport and provide only a limited supply.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A refillable compressed air driven system for dispensing batter comprising
a vessel adapted to hold a determined amount of batter and compressed air,
a compressed air inlet port in said vessel,
a compressed air outlet port in said vessel,
a batter inlet port in said vessel,
a batter outlet port in said vessel,
a compressed air supply line fluidly connected to said compressed air inlet port and configured to supply compressed air through said compressed air supply line to the vessel,
an exhaust valve operably coupled to said compressed air outlet port,
a hopper operably coupled to said batter inlet port, and a batter inlet valve disposed between said hopper and said vessel,
a dispenser operably coupled to said batter outlet port.

2. A refillable compressed air driven system for dispensing batter according to claim 1, further comprising an air compressor operably coupled to the compressed air supply line.

3. A refillable compressed air driven system for dispensing batter according to claim 1, further comprising an oilless air compressor operably coupled to the compressed air supply line.

4. A refillable compressed air driven system for dispensing batter according to claim 1, said vessel comprising a lid releasably attached to a base.

5. A refillable compressed air driven system for dispensing batter according to claim 1, said vessel comprising a lid releasably attached to a base, and a plurality of releasable clamps configured for releasably attaching the lid to the base.

6. A refillable compressed air driven system for dispensing batter according to claim 1, further comprising a pressure relief valve in fluid communication with said vessel and configured to vent compressed air in the vessel in excess of a determined pressure.

7. A refillable compressed air driven system for dispensing batter according to claim 1, further comprising a rigid batter line extending from the batter inlet port in said vessel and being adapted to direct batter from the hopper into the vessel, said hopper being operably coupled to said rigid batter line, and said batter inlet valve being fluidly coupled to said rigid batter line and disposed between said hopper and said vessel.

8. A refillable compressed air driven system for dispensing batter according to claim 1, further comprising a rigid batter line extending from the batter inlet port in said vessel and being adapted to support the weight of the hopper when filled with batter and to direct batter from the hopper into the vessel, said hopper being operably coupled to said rigid batter line, and said batter inlet valve being fluidly coupled to said rigid batter line and disposed between said hopper and said vessel, wherein said hopper comprises a funnel shaped entry configured to feed batter into the rigid batter line.

9. A refillable compressed air driven system for dispensing batter according to claim 1, further comprising an air compressor operably coupled to the compressed air supply line.

10. A refillable compressed air driven system for dispensing batter according to claim 1, further comprising a pressure relief valve in fluid communication with said vessel and configured to vent compressed air in the vessel in excess of 100 psi.

11. A refillable compressed air driven system for dispensing batter according to claim 1, further comprising a flexible dispenser line having a vessel end and a dispenser end, said vessel end being fluidly connected to said batter outlet and said dispenser end being fluidly connected to said dispenser, said flexible dispenser line being configured to communicate batter from said vessel to said dispenser operably coupled to said batter outlet port.

12. A refillable compressed air driven system for dispensing batter according to claim 1, further comprising a flexible dispenser line having a vessel end and a dispenser end, said vessel end being fluidly connected to said batter outlet and said dispenser end being fluidly connected to said dispenser, said flexible dispenser line being configured to communicate batter from said vessel to said dispenser operably coupled to said batter outlet port, and a batter line valve fluidly coupled to said flexible dispenser line and disposed between said vessel and said dispenser.

13. A refillable compressed air driven system for dispensing batter according to claim 1, wherein said dispenser is manually actuated.

14. A refillable compressed air driven system for dispensing batter according to claim 1, further comprising a controller operably coupled to said dispenser and configured to control a time period during which the dispenser remains in an open state when actuated.

15. A refillable compressed air driven system for dispensing batter according to claim 1, further comprising a controller operably coupled to said dispenser and configured to maintain the dispenser in an open state when actuated until a determined amount of batter passes through the dispenser.

16. A method for dispensing batter and enabling quick refilling of a refillable compressed air driven system for dispensing batter according to claim 1, comprising:
Loading batter through the hopper into the vessel,
Charging the vessel with compressed air to a determined pressure range,
Dispensing batter through the dispenser to form units of food products until substantially all of the batter loaded in the vessel is dispensed,
Evacuating the compressed air, and
Repeating the foregoing steps.

17. A method according to claim 16, wherein the step of loading batter through the hopper into the vessel comprises opening the batter inlet valve, pouring the batter into the hopper, allowing the poured batter to flow from the hopper into the vessel, and closing the batter inlet valve after the batter has flowed into the vessel.

18. A method according to claim 16, wherein the step of charging the vessel with compressed air comprises supply compressed air from a compressor into the vessel until a pressure within the determined pressure range is attained.

19. A method according to claim 16, wherein the step of dispensing batter through the dispenser to form units of food products until substantially all of the batter loaded in the vessel is dispensed, comprises repetitively actuating the dispenser until an amount of batter for one unit of food product has been dispensed.

20. A method according to claim 16, wherein the step of evacuating the compressed air comprises opening the exhaust valve.
